(19) United States
(12) Patent Application Publication
(10) Pub. No.: US 2026/0160393 A1
(43) Pub. Date: Jun. 11, 2026

(54) LED FILAMENT

(71) Applicant: SIGNIFY HOLDING B.V., EINDHOVEN (NL)

(72) Inventors: Marcellus Jacobus Johannes VAN DER LUBBE, BEST (NL); Aldegonda Lucia WEIJERS, EINDHOVEN (NL)

(21) Appl. No.: 18/707,616

(22) PCT Filed: Nov. 4, 2022
(86) PCT No.: PCT/EP2022/080829

§ 371 Date: May 6, 2024

(30) Foreign Application Priority Data
Nov. 9, 2021 (EP) 21207264.9

(51) Int. Cl. F21K 9/232; F21K 9/90; F21Y 107/70; F21Y 107/80; F21Y 113/13

(52) U.S. Cl. CPC F21K 9/232; F21K 9/90; F21Y 2107/70; F21Y 2107/80; F21Y 2113/13

(57) ABSTRACT

The present invention relates to an LED filament (10), comprising: a carrier (12) comprising a first elongated carrier portion (14a) with first LEDs (16a), a second elongated carrier portion (14b) with second LEDs (16b), and a third elongated carrier portion (14c) with third LEDs (16c), the third elongated carrier portion being provided between the first elongated carrier portion and the second elongated carrier portion, wherein the carrier is folded along a first longitudinal folding line (15a) separating the first and the third elongated carrier portions and along a second longitudinal folding line (15b) separating the second the third elongated carrier portions into a three-sided structure, for example a triangle shape.

### FIELD OF THE INVENTION

The present invention relates to an LED (light emitting diode) filament, a lamp comprising at least one such LED filament, and a method of manufacturing an LED filament.

### BACKGROUND OF THE INVENTION

Incandescent lamps are rapidly being replaced by LED based lighting solutions. It is nevertheless appreciated and desired by users to have retrofit lamps which have the look of an incandescent bulb. For this purpose, one can simply make use of the infrastructure for producing incandescent lamps based on glass and replace the filament with LEDs emitting white light. One of the concepts is based on LED filaments placed in such a bulb. The appearances of these lamps are highly appreciated as they look highly decorative. US2019017657 discloses a filament type light emitting diode (LED) light source which includes a plurality of LED modules, a coupler, and a common connection portion. The LED modules are in a polygonal prism structure and emit white light having different color temperatures or light of different wavelengths. The polygonal prism structure may be a triangular prism. Each LED module having a bar shape at a respective side surface of the polygonal prism structure and includes a first connection electrode and a second connection electrode. The coupler couples the LED modules to maintain the polygonal prism structure. The coupler may be at an edge of the polygonal prism structure to coupled adjacent ones of the plurality of LED modules. The coupler/coupling member may be made from a material having bonding properties. For example, the coupling member may be an adhesive polymer.

However, a problem with the filament type light emitting diode light source is that it may be difficult/cumbersome/time-consuming to manufacture/assemble.

US2019017657 discloses a filament type light emitting diode (LED) light source that includes a plurality of LED modules, a coupler, and a common connection portion. The LED modules are in a polygonal prism structure and emit white light having different color temperatures or light of different wavelengths. Each LED module having a bar shape at a respective side surface of the polygonal prism structure and includes a first connection electrode and a second connection electrode. The coupler couples the LED modules to maintain the polygonal prism structure. The common connection portion is at one end of the polygonal prism structure and is commonly connected to the second connection electrode of each of the LED modules.

US2018106434 discloses a light emitting diode illumination device comprising a light-transmitting encapsulant, a transparent core, a light source plate stereoscopic structure and a power supply device. The light source plate stereoscopic structure is constituted by a plurality of connecting sub-light source plates. The light source plate stereoscopic structure installed in the light-transmitting encapsulant is connected to the transparent core, and is supported by the transparent core. The sub-light source plate comprises a circuit board body and light-emitting diode dies installed on one surface of the circuit board body by surface-mount technology.

### SUMMARY OF THE INVENTION

It is an object of the present invention to overcome this problem, and to provide an improved LED filament.

According to a first aspect of the invention, this and other objects are achieved by an LED filament, comprising: a carrier comprising a first elongated carrier portion, a second elongated carrier portion, and a third elongated carrier portion arranged alongside each other, the third elongated carrier portion being provided between the first elongated carrier portion and the second elongated carrier portion; first LEDs mounted on a first surface of the first elongated carrier portion for providing first LED filament light; second LEDs mounted on a corresponding second surface of the second elongated carrier portion for providing second LED filament light; and third LEDs mounted on a corresponding third surface of the third elongated carrier portion for providing third LED filament light, wherein the carrier is folded along a first longitudinal folding line separating the first elongated carrier portion and the third elongated carrier portion and along a second longitudinal folding line separating the second elongated carrier portion and the third elongated carrier portion into a three-sided structure.

The third LED filament light may have a different spectrum than the first LED filament light and/or the second LED filament light, for example have different color and/or color temperature than the first LED filament light and/or the second LED filament light. Alternatively or complementary, the third LED filament light may have different CRI than the first LED filament light and/or the second LED filament light.

The present invention is based on the understanding that by folding the carrier into a three-sided structure, for example a triangle shape, rather than applying an adhesive between separate LED modules as in US2019017657, manufacturing of the LED filament may be simplified and/or more efficient. Furthermore, by folding the carrier in the triangle shape, the appearance of the LED filament becomes small (i.e. the LED filament looks thin/narrow/slim) and optical cross-talk between the first/second/third LEDs may be low.

As indicated above, the carrier is preferably folded in a triangle shape. In other words, the carrier may be folded approximately 120 degrees along the first and second longitudinal folding lines such that the carrier has (gets) a triangular cross-section. The folded carrier could here also be described as a triangular prism structure with a hollow center. The three outer sides of the triangle shape/triangular cross-section/triangular prism structure may be formed by the first to third surfaces on which the different LEDs are provided. Alternatively, the carrier could be folded approximately 90 degrees into a U shape.

The carrier may be punctured by holes along the first and second longitudinal folding lines. This may release stress at the folding lines. The holes may be achieved using laser cutting.

Each of the first elongated carrier portion and the second elongated carrier portion may comprise notches configured to allow the LED filament to be arranged in a non-straight configuration. The non-straight configuration may be a curved configuration, such as a ring, a 2D spiral, a 3D spiral, or a helix. By means of the notches, the folded carrier of the LED filament can be bent into the non-straight configuration without deformation.

Specifically, with the triangle shape folded carrier the bending radius is for the second center portion still over the thickness of the carrier, but for the first and second outer portions, the bending radius goes over the axial width. Without the notches, tensile stress and compressive forces in the material would deform the folded carrier into an irregular shape leading to e.g. an irregular spiral shape of the LED filament when mounted on a pumpstem of a lamp. But with these notches, space is provided for the material of the first and second carrier portions to bend over the width of the LED filament. Pull and push forces may be eliminated or minimalized to such a level where deformation of the LED filament is acceptable when assembled. Alternatively, the LED filament could be arranged in straight configuration, whereby the notches can be omitted.

The notches may be placed at regular intervals along the length of the carrier. This may allow the carrier of the LED filament to be nicely bent with a constant curvature radius. Alternatively, the notches could be placed at irregular intervals along the length of the carrier. For example, there could be a higher notch density on the beginning of the LED filament than on the end (e.g. when the curvature radius of the LED filament varies over the length of the LED filament).

Each notch of the first elongated carrier portion may extend from a first longitudinal edge of the first elongated carrier portion towards the first longitudinal folding line, wherein each notch of the second elongated carrier portion extends from a second longitudinal edge of the second elongated carrier portion towards the second longitudinal folding line.

Each notch of the first elongated carrier portion may be V-shaped and point to the first longitudinal folding line, wherein each notch of the second elongated carrier portion is V-shaped and points to the second longitudinal folding line.

The legs of each V-shaped notch may meet when the LED filament is arranged in the non-straight configuration. The result is a smooth bending curve of the LED filament and the gap of the notch is closed.

A first encapsulant segment for at least one of the first LEDs may be provided between each two subsequent notches of the first elongated carrier portion, wherein a second encapsulant segment for at least one of the second LEDs is provided between each two subsequent notches of the second elongated carrier portion. The first and second encapsulant segments may for example comprise a luminescent material that is configured to at least partly convert light from the LEDs into converted light. The luminescent material may be a phosphor, such as an inorganic phosphor and/or quantum dots or rods. The first and second encapsulant segments may specifically be phosphor doped silicone layer segments.

The first encapsulant segments may form a substantially continuous first encapsulant covering the first LEDs and the second encapsulant segments may form a substantially continuous second encapsulant covering the second LEDs when the LED filament is arranged in the non-straight configuration. That is, (also) the gaps between the silicone layer segments may be closed. This results in two continuous phosphor layers when looking at the LED filament.

The first LED filament light may be white first LED filament light, wherein the second LED filament light is white second LED filament light of a different color temperature than the white first LED filament light, and wherein the third LEDs are RGB (red green blue) LEDs for emitting colored third LED filament light. The first LEDs may for example be blue and/or UV LEDs over which the first encapsulant segments are provided, whereas the second LEDs may be blue and/or UV LEDs over which the second encapsulant segments are provided. To this end, by folding the carrier into the three-sided shape, crosstalk which otherwise occurs when blue light from the RGB LEDs also addresses the phosphor of the first and second encapsulant segments is significantly reduced. In other words, the blue LEDs in the RGB portion of the filament cannot excite the phosphors of the other portions of the filament. The white first LED filament light could be warm(er) white first LED filament light. The white second LED filament light could be cool(er) white second LED filament light. The color temperature of the white first LED filament light could for example 2700K. The color temperature of the white second LED filament light could for example be 4000K. Alternatively, the first, second, and third LED filament light could all be white LED filament light (multi-CCT white filament), wherein the blue of one CCT (e.g. a cool white channel) cannot activate the phosphor in a neighboring (warmer) white channel, thus not changing the CCT of the neighboring channel. In another alternative, the RGB LEDs could be mounted on one of the outer elongated carrier portions (i.e. on the first elongated carrier portion or the second elongated carrier portion), whereas the LEDs for the white first and second LED filament light are mounted on the central/third elongated carrier portion and the other outer elongated carrier portion, respectively. The encapsulants/encapsulant segments may be arranged accordingly.

The width w of each of the first, second, and third elongated carrier portions may be in the range of 1-3 mm, preferably 1.2-1.5 mm. The length L of the carrier may be at least 5 times this width (L≥5 w).

The carrier can be made of a foil. The foil may be flexible. The foil may be transparent. The foil may have a thickness of about 0.01 mm. The carrier may for example be a transparent polyimide carrier (flex) foil.

According to a second aspect of the present invention, there is provided a lamp comprising at least one LED filament according to the first aspect. The lamp may (hence) be an LED filament lamp. The lamp may further comprise a light transmissive envelope at least partly surrounding said at least one LED filament, and a connector for electrically and mechanically connecting the lamp to a socket. The lamp may for example be retrofit light bulb.

According to a third aspect of the present invention, there is provided a method of manufacturing an LED filament according to the first aspect, wherein the method comprises: providing the carrier; and folding the carrier along the first and second longitudinal folding lines into a three-sided structure, for example a triangle shape. This aspect may exhibit the same features and technical effects as the first aspect, and vice versa. It is noted that the invention relates to all possible combinations of features recited in the claims.

### BRIEF DESCRIPTION OF THE DRAWINGS

These and other aspects of the present invention will now be described in more detail, with reference to the appended drawings showing embodiment(s) of the invention.

FIG. 1 is a cross-sectional view of an LED filament according to one or more embodiments of the present invention.

FIG. 2 is a partial perspective view of the LED filament of FIG. 1.

FIGS. 3-4 show notches on the LED filament before and after bending.

FIG. 5 is a side view of the LED filament arranged in a helical configuration.

FIG. 6 is a side view of a lamp comprising the LED filament.

FIG. 7 is a flow chart of a method of manufacturing an LED filament.

FIGS. 8-9 illustrates manufacturing of the LED filament.

As illustrated in the figures, like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

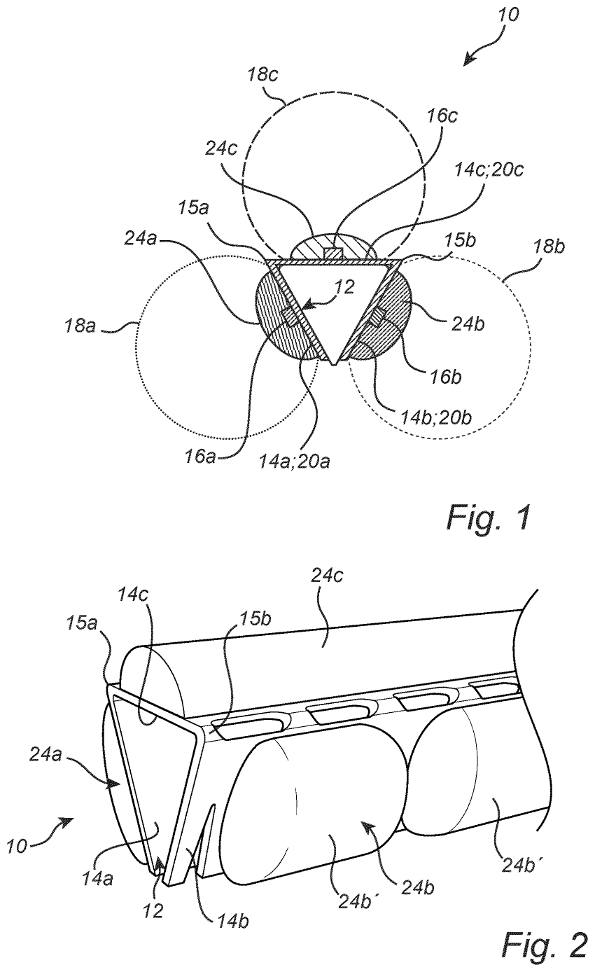

FIGS. 1-2 show a multi-channel LED (light emitting diode) filament 10 according to one or more embodiments of the present invention.

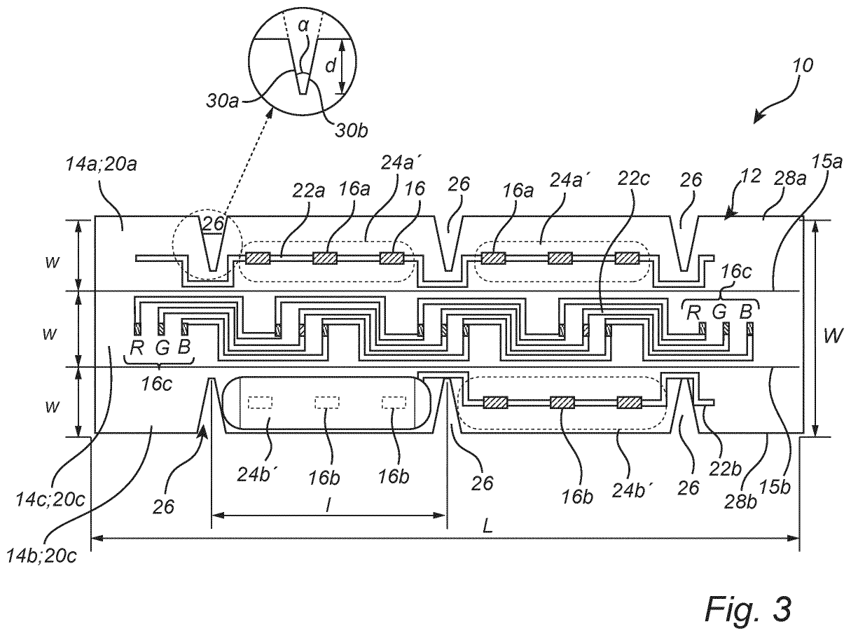

The LED filament 10 comprises a carrier 12. The carrier 12 may have a width W in the range of 3.5-4.5 mm (see FIG. 3). The carrier 12 may have a length L. The carrier 12 may have a thickness of about 0.01 mm. The carrier 12 may for example be a transparent polyimide carrier flexible foil.

The carrier 12 comprises a first elongated carrier portion 14a, a second elongated carrier portion 14b, and a third elongated carrier portion 14c. The portions 14a-c are arranged alongside each other. The third elongated carrier portion 14c is provided between the first elongated carrier portion 14a and the second elongated carrier portion 14b. The first elongated carrier portion 14a and the third elongated carrier portion 14c are defined by a first (longitudinal) folding line 15a. Likewise, the second elongated carrier portion 14b and the third elongated carrier portion 14c are defined by a second (longitudinal) folding line 15b. The width w of each of the first, second, and third elongated carrier portions 14a-c may be in the range of 1-3 mm, preferably 1.2-1.5 mm. The length L of each carrier portion 14a-c may be at least 5 times its width w, L≥5 w.

The LED filament 10 further comprises first LEDs 16a for providing first LED filament light 18a. The first LEDs 16a are mounted on a (first) surface 20a of the first elongated carrier portion 14a. The first LEDs 16a may be arranged in a linear array in a longitudinal direction of the first elongated carrier portion 14a. A first electrical circuit 22a may connect the first LEDs 16a. The first electrical circuit 22a may be or form part of a flexible printed circuit (FPC).

The LED filament 10 further comprises second LEDs 16b for providing second LED filament light 18b. The second LEDs 16b are mounted on a (second) surface 20b of the second elongated carrier portion 14b. The second LEDs 16b may be arranged in a linear array in a longitudinal direction of the second elongated carrier portion 14b. A second electrical circuit 22b may connect the second LEDs 16b. The second electrical circuit 22b may be or form part of a flexible printed circuit (FPC).

The LED filament 10 further comprises third LEDs 16c for providing third LED filament light 18c. The third LEDs 16c are mounted on a (third) surface 20c of the third elongated carrier portion 14c. The third LEDs 16c may be arranged in at least one linear array in a longitudinal direction of the third elongated carrier portion 14c. A third electrical circuit 22c may connect the third LEDs 16c. The third electrical circuit 22c may be or form part of a flexible printed circuit (FPC).

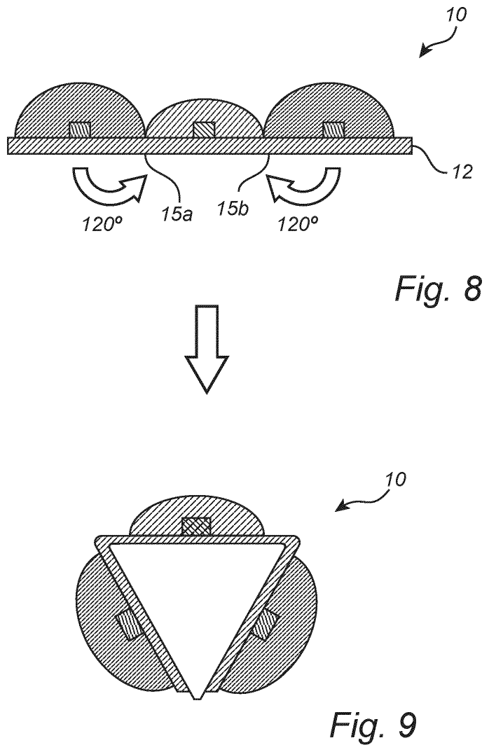

The first, second, and third surfaces 18a-c could be regarded as corresponding surfaces as they form part of, or originates from, the same major surface of the carrier 12, as appreciated in particular from FIGS. 8-9.

In the illustrated embodiment, the first LED filament light 18a is white first LED filament light 18a, preferably warm white WW (e.g. 2700K), the second LED filament light 18a is white second LED filament light 18b, preferably cool white CW (e.g. 4000K), whereas the third LEDs 16c are RGB LEDs for emitting colored third LED filament light 18c. The first LEDs 16a may for example be blue LEDs covered by a first encapsulant 24a comprising phosphor. Likewise, the second LEDs 16b may be blue LEDs covered by a second encapsulant 24b comprising phosphor. The red, green, and blue LEDs of the third LEDs 16c may be arranged in triplets, as shown in FIG. 3. The third LEDs 16c may be covered by a third encapsulant 24c. The third encapsulant 24c may be continuous. The third encapsulant 24c may be transparent or scattered (and without phosphor or the like for wavelength conversion). The third encapsulant 24c may be a silicone layer. Each of the first, second, and third encapsulants 24a-c may be domed.

The electrical circuits 22a-c may be configured such that the first LEDs 16a, second LEDs 16c, and the red, green, and blue LEDs of the third LEDs 16c are individually addressable (channel-wise).

In accordance with the present invention, the carrier 12 is folded at the first and second longitudinal folding lines 15a-b so that it forms a three-sided structure. The carrier 12 is preferably folded in a triangle shape, as illustrated for example in FIGS. 1-2. The triangle shape may have equal sides. The carrier 12 is folded such that the surfaces 20a-c with the different LEDs 16a-c form the outer sides of the three-sided structure/triangle shape. The carrier 12 is typically folded during manufacturing of the LED filament 10, as will be discussed later in conjunction with FIGS. 7-9.

By folding the multi-channel LED filament 10 in a triangle shape, the appearance of the LED filament 10 becomes smaller. That is, the dominant width of the LED filament 10 is always that of one of the carrier portions 14a-c, i.e. width w, no matter the viewing angle. Also, cross-talk is significantly reduced. Namely, when the LED filament 10/carrier 12 is folded in a triangle shape with equal sides, the three portions 14a-c will be divided equally over an angle of 360°. The direction of the emitted light 18a-c may then also be divided over 360° (each has 120°), which result in a minimum influence of each other. In particular, the blue light emitted by the third LEDs 16c will not influence the phosphor of the first and second encapsulants 24a-b for CW and WW, respectively. As a result, it may be avoided that the gamut of the LED filament 10 is reduced (especially in the blue corner), that many colors (especially colors with blue content) are poorly reproduced, that the color rendering index (CRI) is low, that the overall LED filament light lacks blue and cyan parts of the spectrum, etc.

Turning to FIGS. 3-5, each of the first elongated carrier portion 14a and the second elongated carrier portion 14b (i.e. each of the outer carrier portions 14a-b) may comprise notches 26 configured to allow the LED filament 10 to be arranged in a non-straight configuration, for example a helix as shown in FIG. 5. By means of the notches 26, the folded carrier 12 can be bent into the non-straight configuration without deformation. The notches 26 may be cut out of the carrier 12, typically during manufacturing of the LED filament 10.

The notches 26 in the first elongated carrier portion 14a may extend from the (first) longitudinal edge 28a towards-but preferably not all the way to-the first longitudinal folding line 15a. Likewise, the notches 26 in the second elongated carrier portion 14b may extends from the (second) longitudinal edge 28b towards-but preferably not all the way to-the second longitudinal folding line 15b. Notably, the first and second electrical circuits 22a-b can be drawn so that they turn off towards the folding lines 15a-b in level with the notches 26, whereby the electrical circuits 22a-b avoids the notches 26. Furthermore, the notches 26 may be V-shaped, pointing to the first and second longitudinal folding line 15a-b, respectively. Also, the notches 26 may be placed at regular intervals I along the length L of the carrier 12.

The size and shape of the notches 26 as well as distance I to the next notch 26 is determined at least by the bending radius of the LED filament 10, e.g. the radius of the circular helix shown in FIG. 5. In case of a radius of 10 mm (i.e. an inner diameter of the helix/spiral in FIG. 5 of 20 mm), each notch 26 could have a depth d of 1.25 mm and an angle a between the legs 30a-b of 28°. The distance I to the next notch 26 may be 7 mm. With these dimensions, the legs 30-b of each V-shaped notch 26 meet in the middle when the LED filament 10 is bent over a diameter of 20 mm. The result is a smooth bending curve of the LED filament 12 and the gap of each notch 26 is closed.

Because of the notches 26 in the first and second elongated carrier portions 14a-b, the aforementioned first and second encapsulants 24a-b may be segmented. Namely, a first encapsulant segment 24a′ for at least one of the first LEDs 16a may be provided between each two subsequent notches 26 of the first elongated carrier portion 14a. In FIG. 3, the first encapsulant segment 24a′ covers three first LEDs 14a. Likewise, a second encapsulant segment 24b′ for at least one of the second LEDs 16b may be provided between each two subsequent notches 26 of the second elongated carrier portion 14b. In FIG. 3, the second encapsulant segment 24b′ covers three second LEDs 14b.

Together with closing the gap of the notches 26 when bending the LED filament 10 in e.g. a helix/spiral shape as discussed above, the gap(s) between the first encapsulant segments 24a′ and the gap(s) between the second encapsulant segments 24b′ are also closed. This results in the two (substantially continuous) first and second encapsulants 24a-b when looking at the LED filament 10. In other words, the first encapsulant segments 24a′ may form (substantially continuous) first encapsulant 24a covering the first LEDs 16a and the second encapsulant segments 24b′ may form (substantially continuous) second encapsulant 24b covering the second LEDs 16b when the LED filament 10 is arranged in the non-straight configuration.

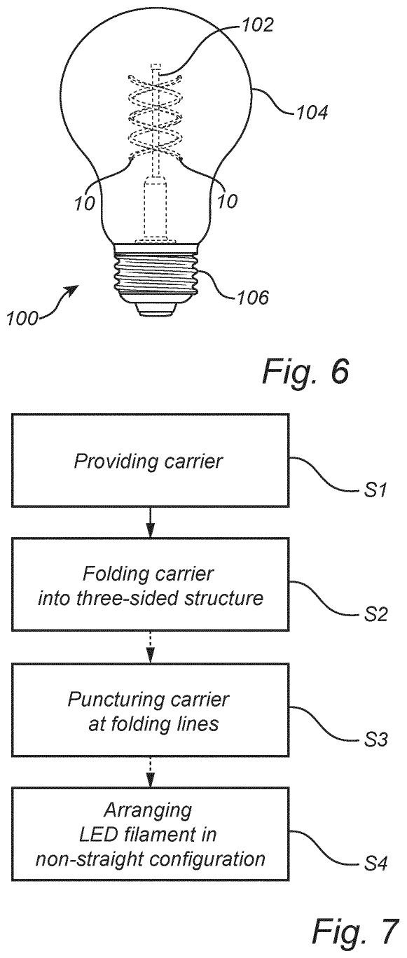

FIG. 6 shows of a lamp 100 comprising two of the muti-channel LED filaments 10 each arranged in a helix/spiral shape. The LED filament(s) 10 will typically be bent into the helix/spiral shape during assembly of the lamp 100. The LED filaments 10 here form a double 3D spiral around a pumpstem 102 of the lamp 100. The lamp 100 may further comprise a light transmissive envelope 104 surrounding the LED filaments 10, and a connector 106 for electrically and mechanically connecting the lamp 100 to a socket (not shown). The envelop 104 is preferably made of glass. The envelop 104 may have various shapes. The connector 106 can be of various types known per se, for example E26 or E27. The lamp 100 may further comprise a controller (not shown) for individually controlling the channels of the LED filament(s) 10. The lamp 100 may for example be retrofit light bulb.

FIG. 7 is a flow chart of a method of manufacturing the LED filament 10.

The method comprises step S1 of providing the non-folded carrier 12 having the first, second, and third LEDs 16a-c, as shown in FIG. 8. This step may include cutting the notches 26 in the outer first and second elongated carrier portions 14a-b.

The method further comprises step S2 of folding the carrier 12 at the first and second longitudinal folding lines 15a-b into a three-sided structure, for example a triangle shape, as shown in FIG. 9. The carrier 12 may be folded with help of a bending mold. By heating the longitudinal folding lines 15a-b with a laser or thermode, the material of the carrier 12 is molten locally. The material at the molten folding lines 15a-b deformed in this way will keep the position after release of the bending mold.

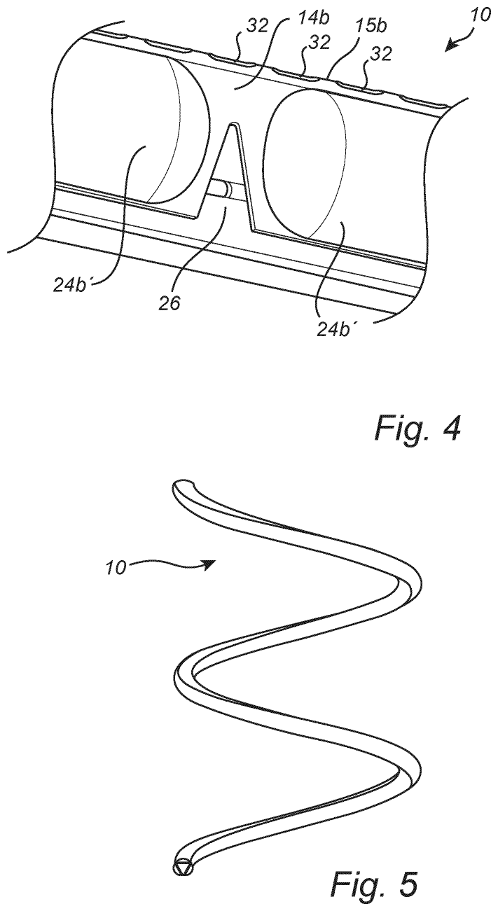

Optionally the folded carrier 12 may be punctured by holes 32 along the first and second longitudinal folding lines 15a-b in step S3, see also FIG. 4. This may release stress at the folding lines 15a-b. The holes 32 may be achieved using laser cutting.

The LED filament 10 may further be arranged in a non-straight configuration in step S4, for example by bending the folded carrier 12 into e.g. the helix/spiral shape.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. An LED filament, comprising:
a carrier comprising a first elongated carrier portion a second elongated carrier portion and a third elongated carrier portion arranged alongside each other, the third elongated carrier portion being provided between the first elongated carrier portion and the second elongated carrier portion;
first LEDs mounted on a first surface of the first elongated carrier portion for providing first LED filament light
second LEDs mounted on a corresponding second surface of the second elongated carrier portion for providing second LED filament light and third LEDs mounted on a corresponding third surface of the third elongated carrier portion for providing third LED filament light,
wherein the carrier is folded along a first longitudinal folding line separating the first elongated carrier portion and the third elongated carrier portion and along a second longitudinal folding line separating the second elongated carrier portion and the third elongated carrier portion into a three-sided structure, and
wherein each of the first elongated carrier portion and the second elongated carrier portion comprises notches configured to allow the LED filament to be arranged in a non-straight configuration.

2. An LED filament according to claim 1, wherein third LED filament light has a different spectrum than the first LED filament light and/or the second LED filament light.

3. An LED filament according to claim 1, wherein the carrier is folded in a triangle shape.

4. An LED filament according to claim 1, wherein said first, second, and third surfaces form outer sides of the three-sided structure.

5. An LED filament according to claim 1, arranged in the non-straight configuration.

6. An LED filament according to claim 1, wherein the non-straight configuration is a curved configuration, such as a ring, a 2D spiral, a 3D spiral, or a helix.

7. An LED filament according to claim 1, wherein the notches are placed at regular intervals along the length of the carrier.

8. An LED filament according to claim 1, wherein each notch of the first elongated carrier portion extends from a first longitudinal edge of the first elongated carrier portion towards the first longitudinal folding line, and wherein each notch of the second elongated carrier portion extends from a second longitudinal edge of the second elongated carrier portion towards the second longitudinal folding line.

9. An LED filament according to claim 1, wherein each notch of the first elongated carrier portion is V-shaped and points to the first longitudinal folding line, and wherein each notch of the second elongated carrier portion is V-shaped and points to the second longitudinal folding line,
wherein preferably the legs of each V-shaped notch meet when the LED filament is arranged in the non-straight configuration.

10. An LED filament according to claim 1, wherein a first encapsulant segment for at least one of the first LEDs is provided between each two subsequent notches of the first elongated carrier portion, and wherein a second encapsulant segment for at least one of the second LEDs is provided between each two subsequent notches of the second elongated carrier portion,
wherein preferably the first encapsulant segments form a substantially continuous first encapsulant covering the first LEDs and the second encapsulant segments form a substantially continuous second encapsulant covering the second LEDs when the LED filament is arranged in the non-straight configuration.

11. An LED filament according to claim 1, wherein the first LED filament light is white first LED filament light, wherein the second LED filament light is white second LED filament light of a different color temperature than the white first LED filament light, and wherein the third LEDs are RGB LEDs for emitting colored third LED filament light.

12. An LED filament according to claim 1, wherein the width of each of the first, second, and third elongated carrier portions is in the range of 1-3 mm, preferably 1.2-1.5 mm.

13. A lamp comprising at least one LED filament according to claim 1.

14. A method of manufacturing an LED filament according to claim 1, wherein the method comprises:
providing the carrier; and
folding the carrier along the first and second longitudinal folding lines into a three-sided structure, for example a triangle shape.
